(19) United States
(12) Patent Application Publication
(10) Pub. No.: US 2013/0154154 A1
(43) Pub. Date: Jun. 20, 2013

(54) COMPOSITE STRUCTURES HAVING CORED MEMBERS

(71) Applicant: William L. Rodman, Seattle, WA (US)

(72) Inventor: William L. Rodman, Seattle, WA (US)

(21) Appl. No.: 13/533,286

(22) Filed: Jun. 26, 2012

Related U.S. Application Data
(60) Provisional application No. 61/501,633, filed on Jun. 27, 2011.

(51) Int. Cl. B29C 43/00

(52) U.S. Cl. CPC B29C 43/003
USPC 264/257

(57) ABSTRACT

A complex-shaped, three-dimensional fiber reinforced composite structure may be formed by using counteracting pressures applied to a structural lay-up of wetted fibers with cored members embedded there between. The wetted fibers are arranged on pressurizable members and may be configured to include internal structural features, such as shear webs. A reinforcement stiffener may be located adjacent to at least one of the pressurizable members and the wetted fibers that form the internal structural feature. The cored members may be selectively located on various interior and exterior regions or surfaces of the composite structure.

### PRIORITY CLAIM

This application claims priority from U.S. Provisional Patent Application No. 61/501,633 filed on Jun. 27, 2011, and the subject matter of which is incorporated herein by reference in its entirety.

### FIELD OF THE INVENTION

The present invention generally relates to fiber-reinforced composite structures having one or more embedded cored member, such as a honeycomb sheet, and methods for manufacturing such composite structures.

### BACKGROUND OF THE INVENTION

Light weight, reinforced composite structures with honeycomb sheets or other “cored” materials (hereinafter broadly referred to as “cored members”) are utilized in a variety of industries and for a variety of purposes. Cored members include closed cell foam, open cell foam, honeycomb, balsa wood, and many others. The design and manufacturing of composite structures with cored members requires thoughtful consideration throughout both phases. Conventionally, the autoclave process has been known to provide the best results when embedding a cored member into a composite structure. However, autoclave processing exerts tremendous pressure on the cored members, which may cause them to crush or deform by an undesirable amount. Therefore, substantial limitations exist as to how these cored members may be configured and/or arranged in a composite structure. These limitations include, but are not limited to a core chamfer angle, a structural depth, a cell size of the cored member, and a density.

Other composite structure assembly processes, such as Resin Transfer Molding (RTM), cannot replicate autoclave processes because the RTM process forces resin into the fabric, which in turn causes the cells of the cored members to fill with resin. Although this filling problem may be overcome if closed cell foams are used in the RTM process, the closed cell foams create a slew of other structural problems, such as an inferior shear strength, resin richness around the imprecisely machined cored members, fabric wrinkles due to low pressure areas, and crack propagation. These problems make integrating or embedding cored members into composite structures using the RTM process impractical and inferior when compared to the autoclave process.

Another composite assembly process that can be used to integrate or embed cored members into a composite structure, but is limited to simple configurations for the composite structure, is called bladder molding. At present, however, it is not possible to integrate or embed cored members into a complex shaped composite structure using the bladder molding process.

### BRIEF SUMMARY OF THE INVENTION

The present invention is generally directed toward processes and structures made by those processes in which one or more cored members are embedded and/or integrated into a complex, three dimensionally shaped fiber-reinforced composite structure. Furthermore, the present invention generally relates to complex-shaped three-dimensional fiber reinforced composite structures and methods of making the same using autoclave, oven or other techniques while minimizing buckling, warping, distortion or other undesirable phenomena during the manufacturing process. One aspect of the invention provides a method for manufacturing complex-shaped, three-dimensional composite structures using counteracting acting pressures applied to a structural lay-up of fiber plies where these pressures operate to embed or integrate cored members between fiber plies with the objectives of minimizing structural weight while increasing localized stiffness.

In one aspect of the present invention, a method of making a composite structure within a tool includes the steps of (1) arranging a plurality of pressurizable members within the tool, each of the pressurizable members having a desired shape before pressurization that includes an outer surface and an inner surface defining a volumetric region, each of the pressurizable members further having an opening to permit internal pressurization thereof, wherein at least one of the pressurizable members includes a recessed region; (2) arranging a first plurality of fiber plies onto at least one surface of each of the plurality of pressurizable members, wherein at least some of the first fiber plies are placed onto the recessed region to substantially conform therewith; (3) placing a cored member onto the recessed, first fiber plies, the cored member complementarily configured to conform to the recessed portion; (4) arranging a second plurality of fiber plies onto the first plurality of fiber plies and onto the cored member to substantially form the composite structure; (5) pressurizing an outer surface of the composite assembly with a first pressure; and (6) pressurizing the inner surface of the pressurizable members with a second pressure, wherein the first pressure and the second pressure operate to compress the fiber plies without crushing the cored member.

### BRIEF DESCRIPTION OF THE DRAWINGS

Preferred and alternative embodiments of the present invention are described in detail below with reference to the following drawings:

FIG. 1A schematically shows a method of making a complex shaped, three-dimensional composite structure in a mold optionally having resin feeder grooves where fiber plies are arranged on sufficiently rigid pressurizable members and pressurized within the mold using a bagging film according to an embodiment of the invention;

FIG. 1B schematically shows a method of making a complex shaped, three-dimensional composite structure in a mold where fiber plies are arranged on sufficiently rigid and interconnected pressurizable members within the mold according to an embodiment of the invention;

FIG. 2 schematically shows an alternative method of making a complex shaped, three-dimensional composite structure in a mold having resin feeder grooves where fiber plies are arranged on sufficiently rigid pressurizable members and pressurized within the mold using sealed mold halves according to an embodiment of the invention;

FIG. 3 shows the fiber plies arranged on the sufficiently rigid pressurizable members according to an embodiment of the invention;

FIG. 4 is a perspective view of a composite structure according to an embodiment of the invention;

FIG. 5 is a perspective view of another composite structure according to another embodiment of the invention;

FIG. 6 is a side, cut-away view of a composite structure assembled in a tool according to an embodiment of the invention;

FIG. 7 is a perspective view of a bottom tool for assembling a composite structure according to an embodiment of the invention;

FIG. 8 is a perspective view of the lower bottom tool of FIG. 7 with an upper tool located thereon according to an embodiment of the invention;

FIG. 9 is a perspective view of a plurality of pressurizable members selectively arranged onto fiber plies that are laid onto the bottom tool of FIG. 7 according to an embodiment of the invention;

FIG. 10 is a perspective of a composite structure, with pressurizable members still located within the structure, made in accordance with an embodiment of the invention; and

FIG. 11 is a perspective of the composite structure of FIG. 10 with the pressurizable members removed according to an embodiment of the invention.

### DETAILED DESCRIPTION OF THE INVENTION

In the following description, certain specific details are set forth in order to provide a thorough understanding of various embodiments of the invention. However, one skilled in the art will understand that the invention may be practiced without these details. In other instances, well-known structures associated with composite structures, the tooling to produce the same, and methods of making, configuring and/or operating any of the above have not necessarily been shown or described in detail to avoid unnecessarily obscuring descriptions of the embodiments of the invention.

The present invention is generally directed to the inclusion of cored members, such as a honeycomb, within a composite structure. U.S. patent application Nos. 11/835,261; 12/176,981; 12/330,391; and 12/565,602 describe how pressurizable members may be arranged to produce complex-shaped composite assemblies and/or structures, and those patent applications are hereby incorporated by reference in their entireties. The present invention is further directed to overcoming the problems related to lying up and including, embedding and/or integrating cored members into composite structures. Cored members, such as honeycomb sheets, are often arranged between fiber plies as a way to stiffen a panel or structure, reduce weight, and increase a buckling strength of the panel or structure.

Generally, a composite structure includes a laminate area between integral ribs. The laminate area is commonly referred to as a panel. Thus, a core-stiffened panel is a laminate that uses a cored feature, such as a honeycomb sheet, to increase its buckling strength. A complex-shaped composite structure is understood to have multiple panels, which in turn means that it will include multiple “bays” that, using conventional composite assembly methods, must be fastened together. The processes and structures made therewith according to the present invention may produce complex-shaped composite structures wherein the cored members are integrated into the composite structure during a fiber ply lay-up process.

There are many types of core materials, such as syntactic foam, closed cell foam, and honeycomb. Syntactic foam is made by mixing glass “micro-balloons” with epoxy resin. A glass micro-balloon is a microscopic hollow sphere of glass. This mixture can be extruded into sheet form and applied during the composite panel lay-up process. Generally, syntactic foam is relatively heavy as compared to honeycomb and does not provide a crack stopping capability in the event a micro-crack or crack was to propagate in the structure.,

Closed cell foam is manufactured by mixing resin with a blowing agent. The resin is cast into sheet form and then subjected to high heat activation energy. Once the resin reaches the appropriate temperature, the blowing agent reacts and causes bubbles to form within the sheet. This process can be carefully managed to produce consistent weight density material with predictable properties. Disadvantages present themselves when a processor has to slice, cut, or “chamfer” the closed cell foam. At the sliced edges, the cells are no longer closed and cavities are created where resin can accumulate. When film adhesive is used in autoclave processed panels, filleting of the cells is not uniform, which leads to high stress concentrations in some locations. This can cause a shear failure node and result in unpredictable skin failure.

Use of a closed cell foam material in resin transfer molding (RTM) and infusion can stabilize the skins and prevents buckling. Therefore, the number of plies in the skins can be reduced. However, when closed cell foam is used to stiffen panels in the RTM process, the cut cells may still accumulate resin. The resin-filled cavities add parasitic weight to the structure. In both processes (autoclave process and RTM), the closed cell foam does not have sufficient crack stopping properties that may prevent undesired crack propagation. It should be noted that closed cell foam is the material of choice when RTM and infusion processes are used. This is because honeycomb naturally fills with resin during this type of processing. So, inherently, RTM and infusion designs that baseline closed cell foam use sub-standard materials in order to mitigate process limitations.

NOMEX® and fiberglass honeycomb cored members are well known in the aerospace industry. NOMEX® cored members are made from non-woven fiber sheets that have been advantageously registered with printed glue lines in a special pattern and then the sheets are compiled in a specific manner and cured. Once cured, the assembled sheet stack is pulled open like an accordion and then dipped in resin to fix its configuration. Core density is increased by repeating the resin dipping process. The inherent advantage to honeycomb is that the sheet material has fibers within it, thereby creating a crack propagation resistance, as well as the inherent low density properties of the expanded cells. Further, in contrast with closed cell foams, honeycomb transmits ultrasonic frequencies well enough to be inspected. Lastly, during autoclave processing, the cell walls transmit or react pressure loads to the fiber plies that are laid on top of, beneath, or on the side of the cored member. This causes natural filleting of the film adhesives or resins and creates a load carrying mechanism from the fiber plies through the cored member. This filleting creates predictable structural properties, compared to that found in closed cell foams.

Consequently, there are inherent disadvantages to conventional processing methods for incorporating sealed honeycomb in RTM and infusion designs, including additional processing to create the sealed core, weight of the additional adhesive, as well as the introduction of a secondarily bonded detail into the lay-up, which is considered an inherent point of delamination should the bond line fail. Accordingly, co-cured honeycomb (honeycomb that is bonded into a lay-up without any pre-cured sealing material), also generally referred to as the cored member herein, is almost always sought by engineers when creating lightweight composite structures.

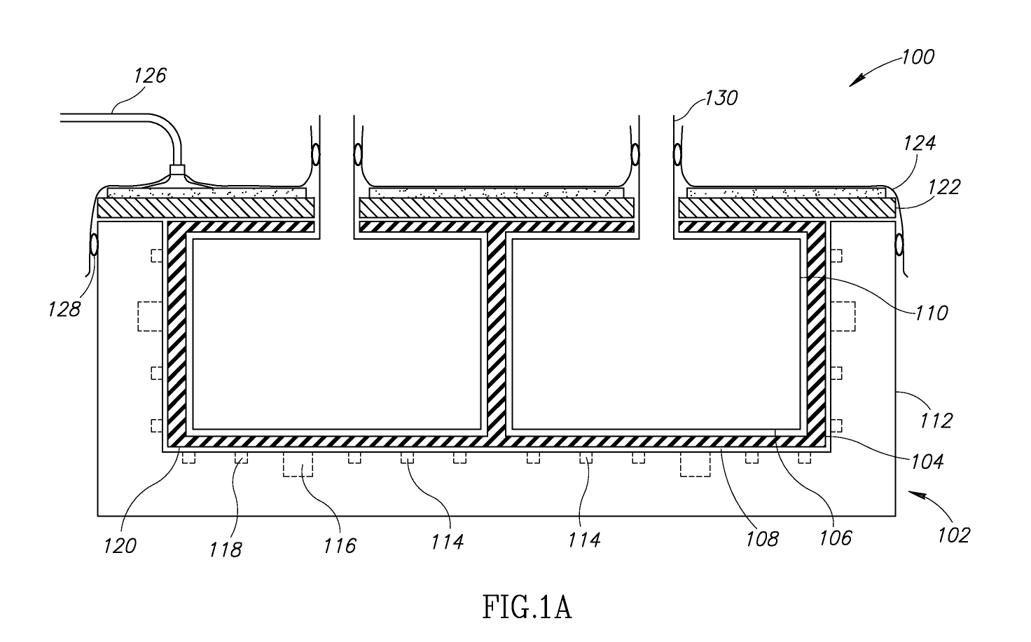

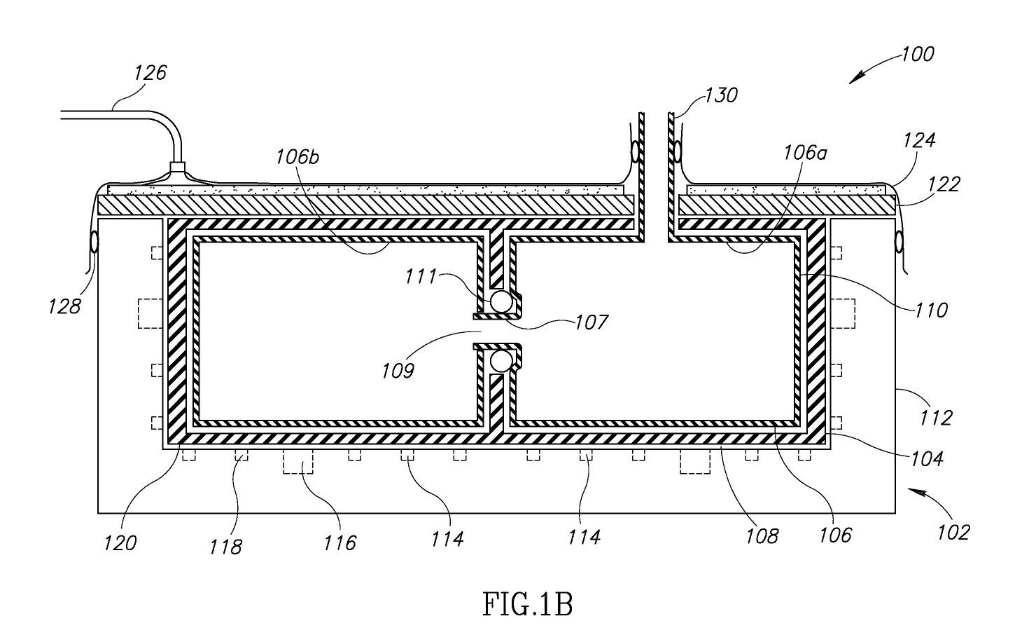

Referring to FIGS. 1A-3, a complex-shaped, three-dimensional fiber reinforced composite structure may be formed by using counteracting acting pressures applied to a structural lay-up of fiber plies. The fiber plies are arranged on pressurizable members that become an integral part of the final product, or may be removed, depending on the accessibility of the member. In a preferred embodiment, the pressurizable member is a hollow rotomolded thermoplastic member, a blow molded thermoplastic member, a super-plastic formed metallic member, or a twin sheet vacuum formed member (TSVF) having an opening or vent. An opening or vent allows an inner surface of the pressurizable member to be vented or pressurized such that it is expanded or inflated against the fiber plies. Advantageously, the vented pressurizable member allows the complex-shaped, three-dimensional fiber reinforced composite structure to be produced using elevated temperature, pressure, and/or autoclave techniques. By means of the opening, pressure within the pressurizable members may be equalized as temperature rises or additional pressure may be applied, as in the use of an autoclave. In one embodiment, a number of the pressurizable members which may be of different sizes and have complex shapes, are arranged to form a large, complex-shaped lay-up surface for the fiber plies.

The ability to equalize the pressure in the pressurizable members allows for the production of complex-shaped, three-dimensional structures such as frames, intercostals, ribs, etc. and further permits the fiber plies to maintain their correct geometric shape. The production of these features often necessitates the creation of interior walls, flanges, shear webs and other structural design features, referred to herein as unsupported, free or internal features that are generally defined as having opposing surfaces adjacent to pressurizable members or as not having a primary surface situated between a pressurizable member and a tooling or mold surface.

FIG. 1A schematically shows an autoclave system 100 having a tooling assembly or mold 102 according to an embodiment of the invention. Fiber plies 104 are arranged on pressurizable members 106 and the resulting assembly 108 is placed in the mold 102. The arrangement of the fiber plies 104 and the manufacturing of the pressurizable members 106 will be described in greater detail below. For purposes of clarity only, the illustrated embodiment shows the outer surface 110 of the pressurizable members 106 as separated or spaced apart from the fiber plies 104. However, during assembly, it is appreciated that the fiber plies 104 are laid up directly onto the outer surface 110 of the pressurizable members 106.

The mold 102 is a leak tight system having a mold body 112 optionally formed with feeder grooves or channels 114 to infuse matrix material (not shown) into or sufficiently wet the fiber plies 104. The feeder grooves 114 may include main feeder grooves 116 and distribution channels 118. Alternatively, the feeder grooves 114 may be included in the pressurizable members 106, which is an embodiment described below. However in many instances, it is preferable to include the feeder grooves 114 into the mold 102 to minimize matrix material pockets, uneven matrix material surfaces, or similar matrix material-related imperfections that could affect the quality of the finished fiber reinforced composite structure. For aerospace components, it is generally considered an unacceptable design condition to have matrix material pockets, uneven matrix material surfaces, or similar matrix material-related imperfections because such imperfections may increase the likelihood of cracking in the residual matrix material. Accordingly, if feeder grooves 114 are utilized than it is preferable to form the feeder grooves 114 into the mold body 112. In one embodiment, the mold 102 is a tightly (i.e., close tolerance) machined clamshell type mold 102.

In one embodiment, a removable, stiffened peel ply 120 may be laid up or take the form as an outer layer or outer ply on the outer surface 110 of the fiber plies 104. The stiffened peel ply 120 could then be peeled or otherwise separated from the fiber plies 104 after the matrix material is cured. By way of example, the stiffened peel ply 120 permits the matrix material associated with the feeder grooves 114 to be peeled away from fiber plies 104 during finishing operations (i.e., post matrix material cure). There are numerous means of injecting or infusing the fiber plies 104 with matrix material and once a decision to use tool side feeder grooves 114 is made, the arrangement, volumetric flow rate, and volumetric capacity, for example, of the feeder grooves 114 may be optimized or otherwise controlled for the particular structural component being manufactured.

As temperature is increased, the different matrix materials may be utilized to achieve improved results. For example and when the matrix material comprises a resin, a number of different resins may be employed based on the processing temperature, for example a polyethylene resin may be used at low temperatures, an epoxy, phenolic, or bismaleimide resing at medium temperatures, and finally a polyimide resin at higher temperatures. In addition to the above, other resins such as nylon, polyethersulfone (PES), polyetherimide (PEI), or acetal may be used to customize the fiber-reinforced structure.

In the illustrated embodiment, the mold 102 may include a caul sheet 122, a bagging film 124, and a probe 126. The caul sheet 122 may be coupled to the mold body 112 to secure the fiber plies 104 and the pressurizable members 106 within the mold 102. The caul sheet 122 may take the form of a sheet or plate material that is generally placed in immediate contact with the fiber plies 104 during curing to transmit normal pressure and provide a smooth surface on the finished component. In one embodiment, the caul sheet 122 takes the form of a stiffened three ply sheet material, but may take other forms depending on the autoclave system 100 and other design considerations.

The bagging film 124 is sealed to various portions of the mold 102 with sealant 128. In addition, the bagging film 124 is sealed to sprues or pressure ports 130 extending from the pressurizable members 106. The bagging film 124 preferably takes the form of a three ply porous breather material, but may take other forms depending on the autoclave system 100 and other design considerations.

The probe 126 typically operates to place the fiber plies 104 under a vacuum pressure by removing a fluid from the mold 102. In other embodiments, however, it is appreciated that the probe 126 may operate to increase the pressure within the mold 102. The bagging film 124 may also be sealed to the probe 126 using the sealant 128. In addition, the fluid may be a gas or liquid, such as, but not limited to, air or oil.

FIG. 1B schematically shows the autoclave system 100 having a tooling assembly, tool or mold 102 according to another embodiment of the invention. The illustrated embodiment is substantially similar to the previous embodiment so that like numbers are re-used except where there are differences. In this embodiment, the fiber plies 104 are arranged on interconnecting pressurizable members 106a and 106b within the mold 102. Again and for purposes of clarity only, the illustrated embodiment shows an outer surface 110 of the pressurizable members 106a, 106b as separated or spaced apart from the fiber plies 104. However during assembly, it is appreciated that the fiber plies 104 are laid up directly onto the outer surface 110 of the pressurizable members 106a, 106b.

The interconnected pressurizable members 106a, 106b are in fluid communication with one another. As illustrated, pressurizable member 106a includes a first fluid port 107 that extends into a second fluid port 109 of pressurizable member 106b. In addition, the fiber plies 104 are arranged so they do not block or interfere with the ports 107, 109. As the pressure inside of pressurizable member 106a is changed via the single sprue 130, the pressure inside of pressurizable member 106b changes accordingly due to the fluid interconnection. To seal the pressurizable members 106a, 106b during pressurization, an amount of sealant 111 may be located around the first fluid port 107. Preferably, the sealant 111 is arranged so that it does not extrude into the fiber plies 104 during pressurization.

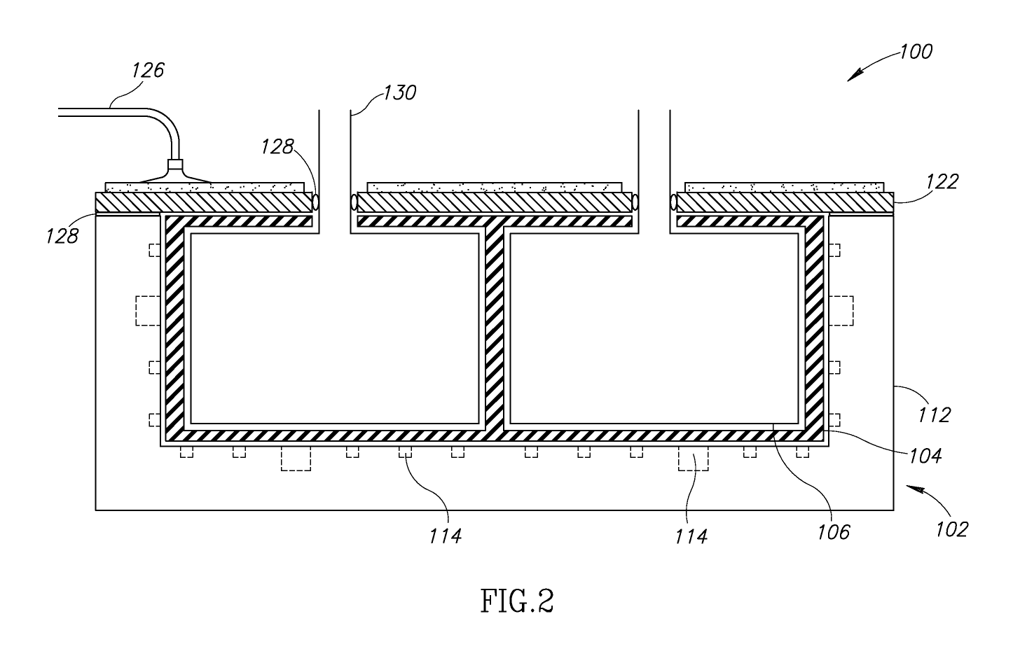

FIG. 2 shows a slightly different embodiment for pressurizing the autoclave system 100 without using the bagging film 124. In this embodiment, the caul sheet 122 is sealed against the mold body 112 of the mold 102 and the sprues 130 of the pressurizable members 106. It is appreciated that other autoclave system 100 configurations and methods of sealing the mold 102 may operate in accordance with the invention, but they will not be further described herein for purposes of brevity.

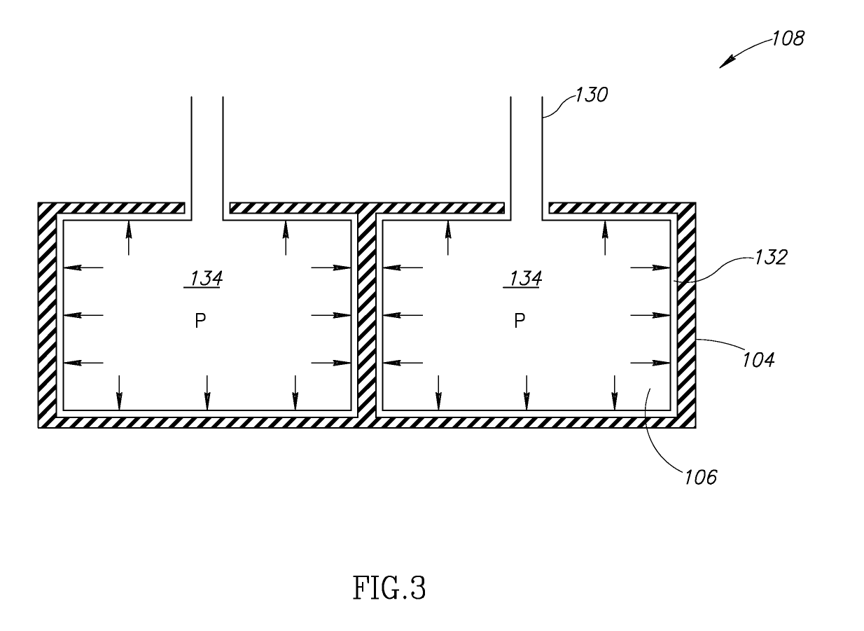

FIG. 3 shows the assembly 108 comprising the fiber plies 104 and the pressurizable members 106. The pressurizable members 106 may be configured to be non-removable after the fiber plies 104 and injected or infused matrix material are cured. The integration of the pressurizable members 106 with the fiber plies 104 to make the flyaway component may or may not be accomplished by using a bondable material therebetween. When making complex flyaway components, it may be desirable to include the pressurizable members 106 as a permanent part of the flyway component. However, the type of material, the size, and the weight of the pressurizable members 106 would likely have to be closely controlled for the flyway component to meet its design requirements. For example, when making aerospace components, the thickness of the pressurizable members 106 will add to the overall weight of the flyway component. If the members 106 are too thin, or if they are not made of a durable material, then the bagging details may collapse, split or explode during pressurization and curing of the assembly 108 within the mold 102 (FIG. 1). Additionally, the presence of the pressurizable members 106 in contact with the fiber plies 104 could affect the engineering properties of the flyway component. In addition, the strength, properties, and structural reliability of the bondable material 132 will need to be tailored for each flyway component to minimize and preferably prevent crack propagation from the bondable material 132 into the cured fiber plies 104.

The pressurizable members 106 are preferably blow molded, TSVF or rotomolded thermoplastic materials with pressurizable inner chambers or volumetric regions 134. The pressurizable members 106 may be manufactured to have complex shapes, contours, and other features onto which the fiber plies 104 are arranged. Each pressurizable member 106 preferably includes at least one opening or sprue 130 to vent the hollow pressurizable member 106 to autoclave pressure or some other pressure “P.” By pressurizing or venting the inner chamber 134, the pressurizable member 106 is urged against the un-cured fiber plies 104 to compress and sandwich the fiber plies 104 between the pressurizable member 106 and the mold 102. This ply compression operates to mitigate wrinkle formation in the flyway component. Because all members operate in unison and expand substantially uniformly the fiber plies are simultaneously placed in tension, which tends to minimize wrinkles in the produced component. In one embodiment, the pressurizable member may be produced from a chemically pure titanium tube in which the titanium tube is super plastically formed to create a metal matrix composite shape.

In one embodiment, the sprue 130 is used to introduce a pressure P into the chamber 134 that is greater than the autoclave pressure. After pressurizing and curing the fiber plies 104, the sprue 130 may vent gases built up in the chamber. By way of example, the sprue 130 may take the form of a fitting coupled to a fluid medium pump or other pressure source. In addition and depending on the arrangement of the assembly 108, the pressurizing and curing of the fiber plies 104 may be accomplished by pressurizing only the chambers 134 of the pressurizable members 106, thus eliminating the need for the bagging film 124 described in FIG. 1. In a preferred embodiment, impregnated (sometimes referred to as pre-impregnated) fiber plies 104 are arranged on the pressurizable member 106. The use of impregnated fiber plies may eliminate the step of injecting or infusing matrix material into the mold 102. In another embodiment, a resin transfer molding process is used to infuse resin into the fiber plies 104 and the pressurizable members 106 are pressurized without being placed in the mold 102.

In one embodiment, a plurality of pressurizable members 106 are coupled together to be in fluid communication with an adjacent pressurizable member 106 such that the fluid medium may flow freely into one of the pressurizable members 106 and simultaneously or contemporaneously pressurize all of the pressurizable members 106 that are in fluid communication with one another. One example of this embodiment is described above with reference to FIG. 1B.

The fiber plies 104 may be laid up or arranged with a 45 degree bias, which permits the pressurizable member 106 to considerably expand during the cure process. Preferably, the arrangement of the fiber plies 104 and the configuration of the pressurizable members 106 cooperate to ensure compression of all fiber plies 104 and thus prevent wrinkles during the cure process.

Instead of using “heavy” monolithic structures, the aerospace industry prefers that flight control surfaces, such as wing sections, be manufactured using “panelized honeycomb core” constructions. A panelized honeycomb core design is one where pre-cured ribs, skins, and spars are assembled using fasteners. The distinguishing feature from monolithic structure is that honeycomb or other core materials are used to stiffen the aerodynamic skins between the ribs and spars. This assembly process allows rib and spar spacing to greatly exceed the nine inch “rule of thumb” for monolithic structures. Sometimes the spacing between ribs and spars can exceed six feet. So, the total weight of ribs and spars is greatly reduced. Designers are constrained by the depth of the cavity when considering core thickness. If they cannot get the required core depth to minimize the number of plies, sometimes they achieve the design objective by maximizing the core depth and adding additional plies. It should be noted that core thickness increases the weight of the component, as well as do the ribs and fasteners and additional plies. So, optimization of the number of plies, ribs, and core thickness is a goal for efficient design that meets weight, strength, operational life and inspection requirements.

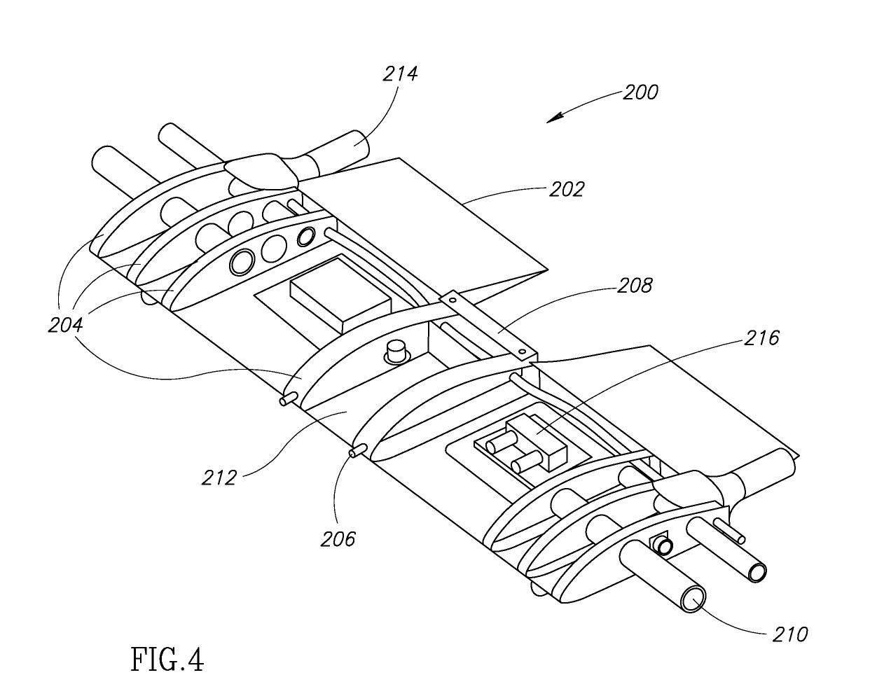

FIG. 4 shows a composite structure 200, with its top surface purposefully removed, taking the form of a wing section according to an embodiment of the present invention. The composite structure 200 may be made using the process described above with regard to FIGS. 1A-3. The composite structure 200 includes a trailing edge 202 having cored members (not shown) located between fiber plies of the trailing edge 202. The composite structure 200 also includes integral ribs 204. Further a forward attachment device 206 and a rear attachment device 208 are included for attaching the wing section to a fuselage (not shown) of an aircraft (not shown). The composite structure 200 may still further include one or more spar tubes 210, an oil tank 212, a boom attachment device 214 and an antenna 216.

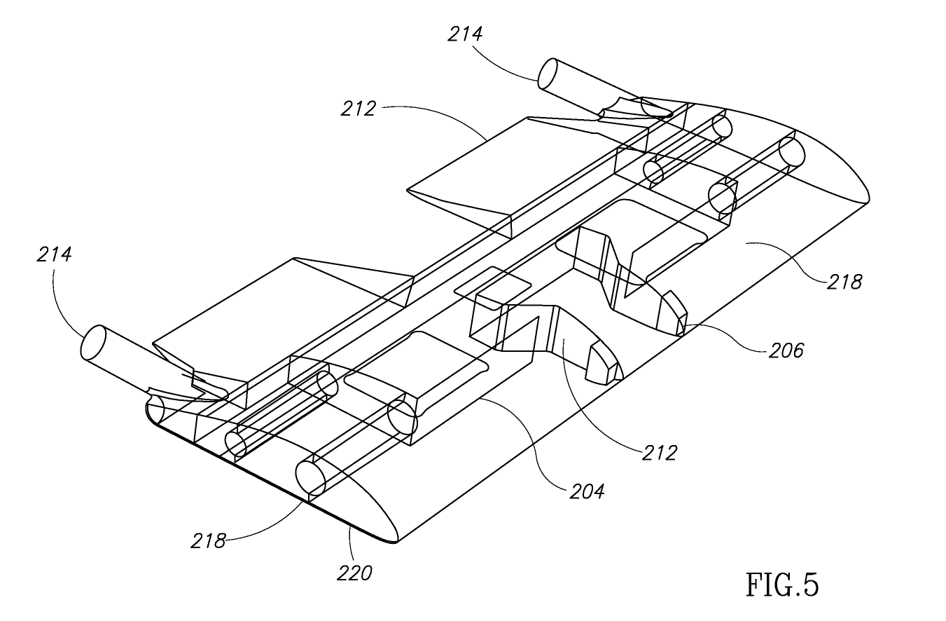

FIG. 5 shows a “see-through” version of the composite structure 200 of FIG. 4. In the illustrated embodiment, an upper wing section panel 218 and a lower wing section panel 220 may have cored members (not shown) embedded between respective fiber plies that comprise the panels 218, 220. In addition, the trailing edge panels 202 may have cored members (not shown) embedded therein. The embedded cored members will be shown and described in detail with respect to the upcoming drawings.

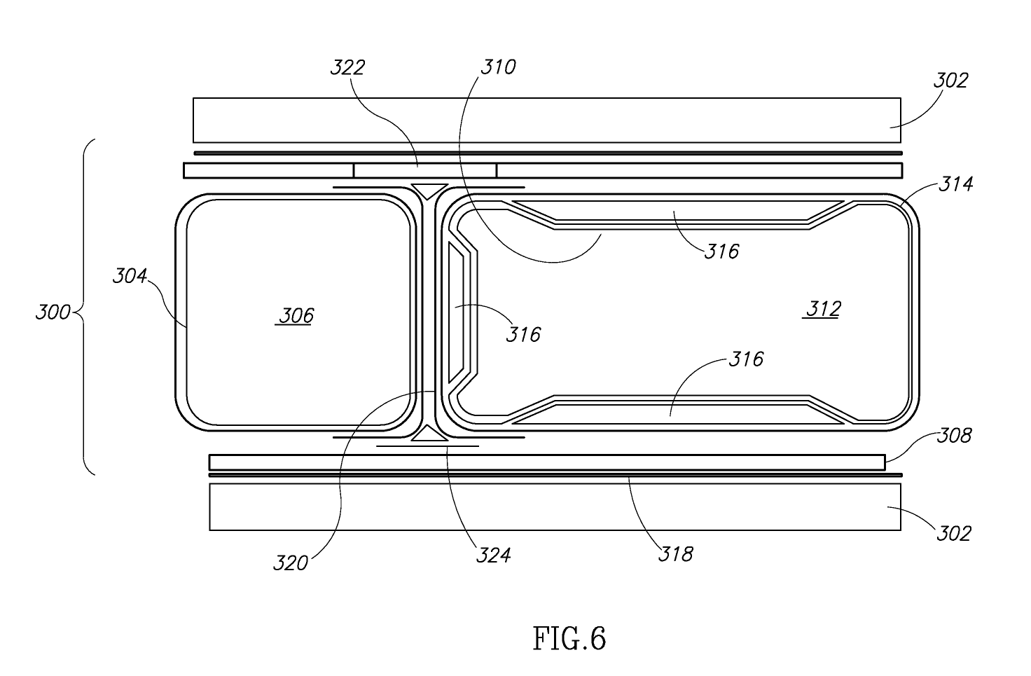

FIG. 6 schematically shows a composite assembly 300 located within a tool 302. The composite assembly 300 includes a first pressurizable member 304 having a pressurizable interior region 306. The composite assembly 300 further includes a second pressurizable member 308 having recessed portions 310 and a pressurizable interior region 312. In one embodiment, the recessed portions 310 are formed when the pressurizable member 308 is molded or otherwise created.

Further during the lay-up process of the composite assembly 300 within the tool, a first plurality of fiber plies 314, which may take the form of a fabric layer or layers, are laid onto the pressurizable member 308 and are either forced to conform (e.g., by pressing and manipulating) or permitted to conform (e.g., by gravity), to the recessed portions 310 and then cored members 316 are placed, respectively, onto the recess-conformed fiber plies 314 and seated into the recessed portions 310. At that point, another layer of fiber plies 318 are placed onto the cored members 316 to form a composite assembly. In the illustrated embodiment, the cored member 316 adjacent a rib 320 may operate to stiffen the rib 320, which would minimize or eliminate buckling of the rib 310 during crushing loads. In addition, the cored members 316 on the top and bottom of the assembly, respectively, may operate to stiffen the panels and prevent them from buckling under compression loading scenarios.

In some instances, it may be desirable to stiffen the entire skin of a composite assembly. As such, additional cored members 316 may be added at other locations. Optionally, solid laminate plies 322 may be added adjacent to the rib 320 to prevent peeling or shear loads from causing core delamination. If solid laminate plies are not used, then optionally bridge plies 324 may be used to keep the cored member 316 from deforming into the radius during cure operations. While the illustrated embodiment shows three cored members 316, it is understood that a fewer or lesser number of cored members may be used to selectively stiffen various regions of the composite assembly.

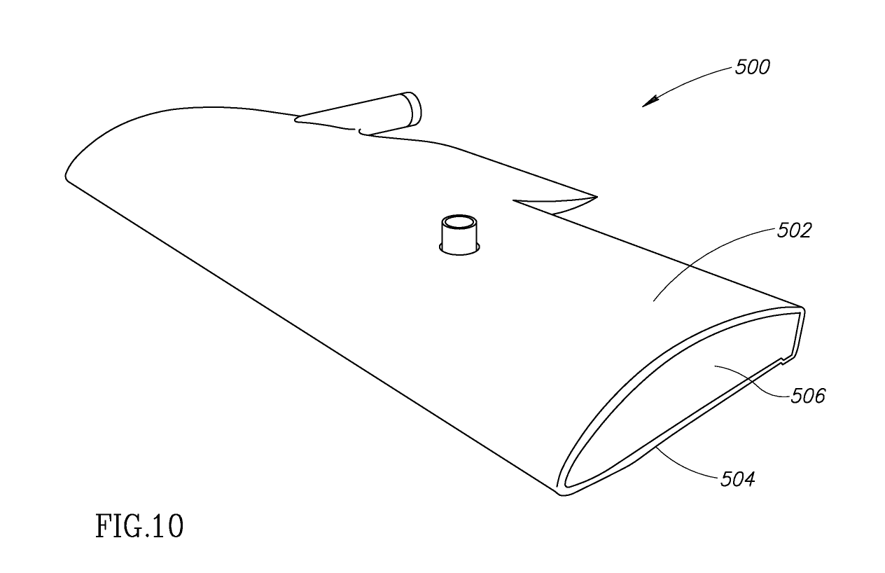

Advantageously, the above-described composite structure manufacturing process may eliminate the bagging operations that are commonly required during autoclave processes. Additionally, the pressurizable members 304 are more stable and robust than bagging materials and their tolerances may be precisely controlled. Accordingly, the pressurizable members used with one or more cored members may prevent existing processing problems, such as “core crush” from occurring. In one embodiment, this advantage may be enhanced by increasing a chamfer angle 514 (FIG. 12) of the cored member along one or more edges. At least in some composite structures, a steeper chamfer angle 514 (FIG. 10) may result in a lighter part because it effectively stiffens the panel closer to the rib 320 (FIG. 6).

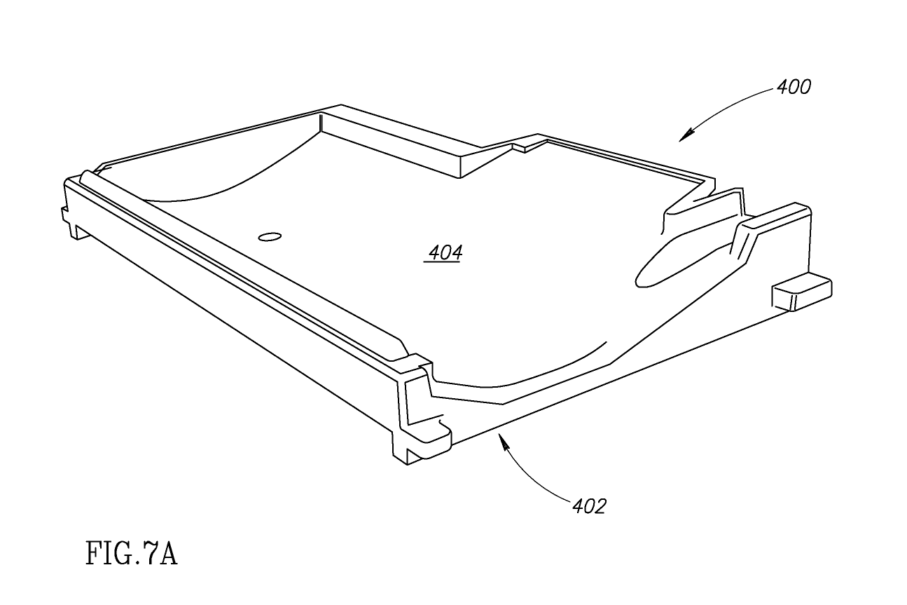

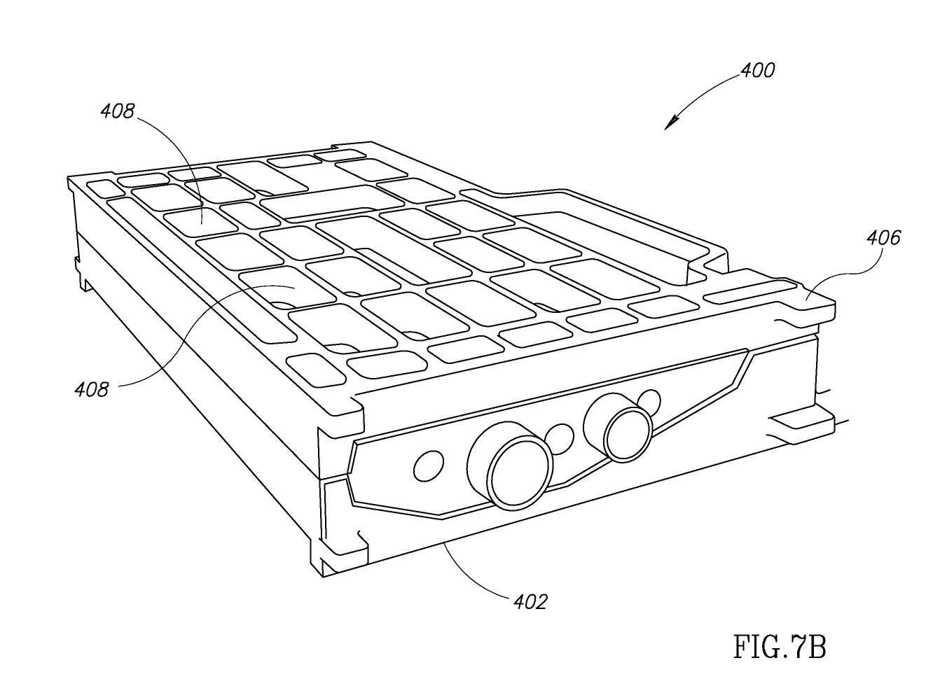

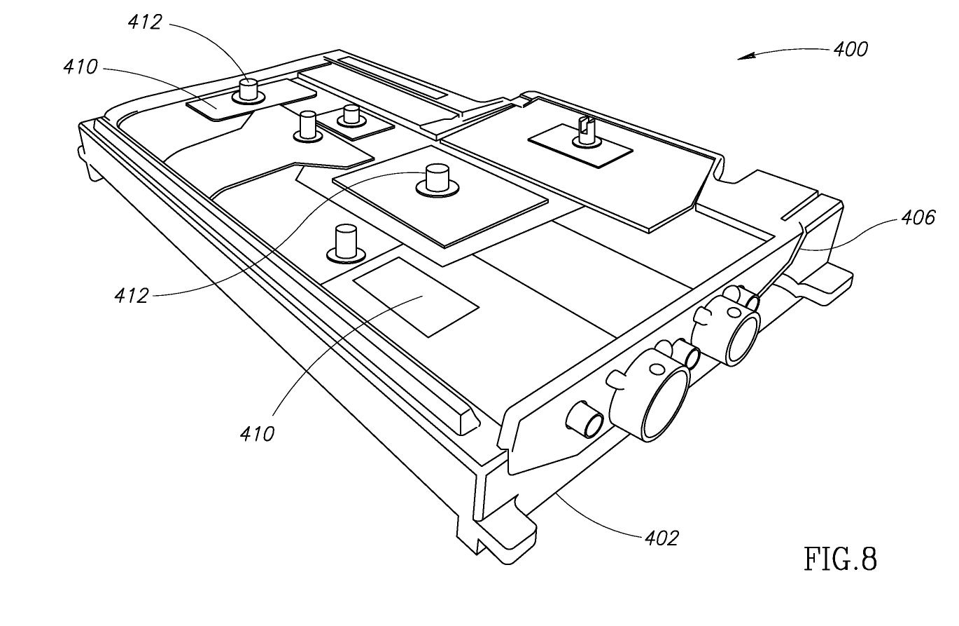

FIGS. 7A-9 briefly show an assembly process 400 for configuring a composite structure or assembly according to an embodiment of the present invention. FIG. 7A shows a bottom tool 402 with a tool support surface 404. FIG. 7B shows an upper tool 406 having a plurality of cavities 408 configured to receive pressurizable members 410 (FIG. 8).

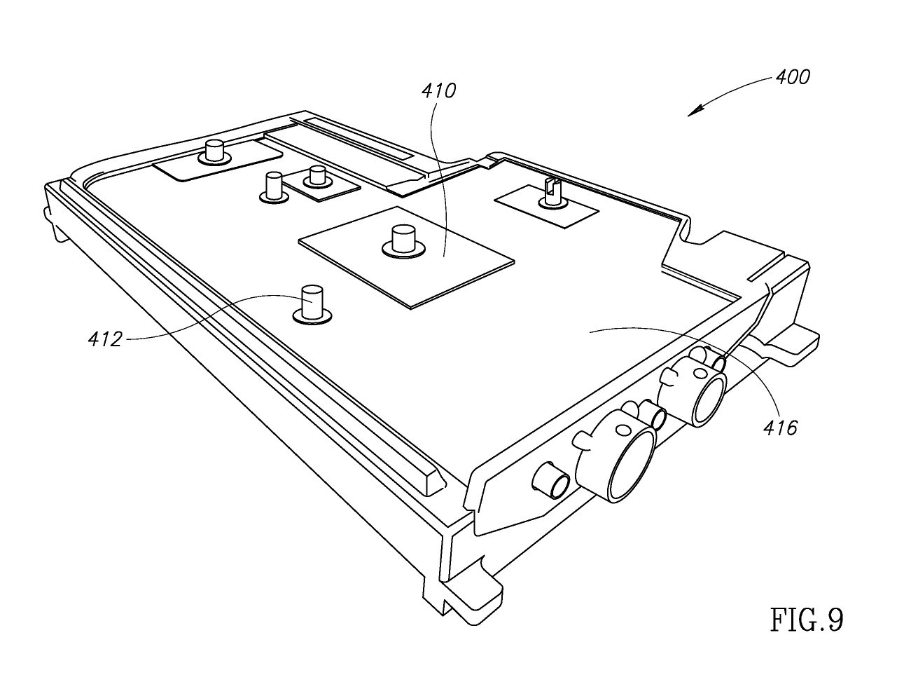

FIG. 8 shows a plurality of pressurizable members 410 arranged onto fiber plies, which are arranged beneath the pressurizable members 410. At least some of the pressurizable members 410 have external sprues or ports 412 for communicating with a pressure source (not shown). FIG. 9 shows one or more fiber ply sheets 416 placed onto the pressurizable members 410 while still permitting the external ports 412 to remain visible. The illustrated assembly shows the composite structure before the pressurizing and curing processes.

FIG. 10 shows a composite structure 500, which takes the form of a wing section, made according to the above-described assembly process after the pressurizing and curing processes. The composite structure 500 includes a top surface 502 and a bottom surface 504 that have been compacted by the counteracting pressures, as previously described. As illustrated, the pressurizable members 506 have not yet been removed from the composite structure 500.

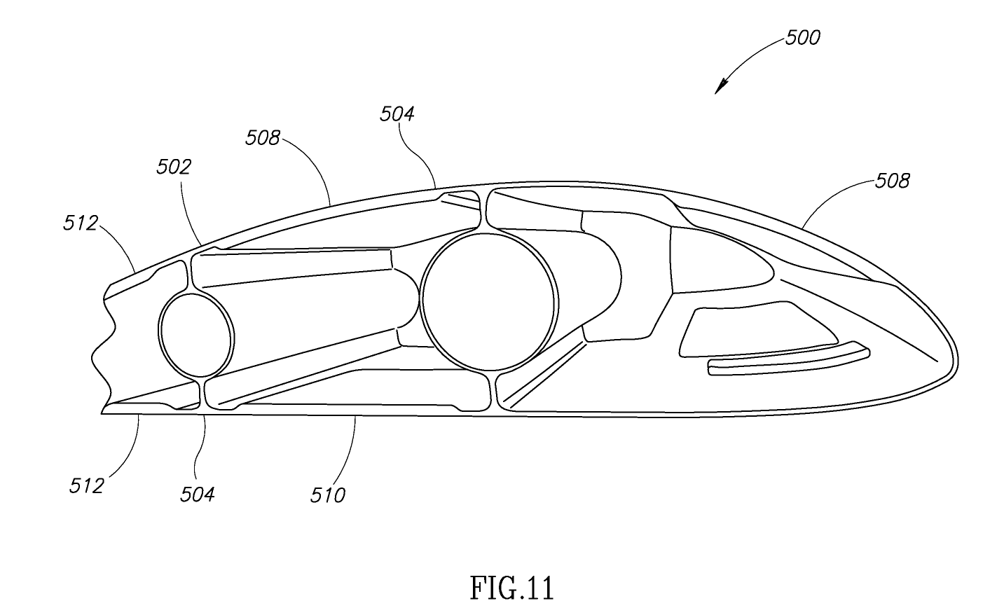

FIG. 11 shows a cross-sectional cut of the composite structure 500 after the pressurizable members 506 (FIG. 10) have been removed. The composite structure 500 includes embedded, cored members, specifically two upper surface cored members 508, a lower surface cored member 510, and respective upper and lower trailing edge cored members 512.

The above-described processes and resulting composite structures incorporate cored members into the structures. Consequently, composite structures with cored members selectively embedded therein may be manufactured with large spans between ribs or other supports. This assembly process may advantageously result in ribs and spars that do not require fasteners or flange overlap plies, which in turn significantly reduces the weight of the overall composite structure. Further, if additional ribs and spars were to be added to the composite structure, then the thicknesses of the cored members could be substantially reduced because the span between them is reduced. In short, the inclusion of the cored members according to the described process permits a variety of design options that were not previously available. It should be further noted that reduced fiber ply counts and lighter weight implies reduced cost.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method of making a composite structure within a tool, the method comprising:
arranging a plurality of pressurizable members within the tool, each of the pressurizable members having a desired shape before pressurization that includes an outer surface and an inner surface defining a volumetric region, each of the pressurizable members further having an opening to permit internal pressurization thereof, wherein at least one of the pressurizable members includes a recessed region;
arranging a first plurality of fiber plies onto at least one surface of each of the plurality of pressurizable members, wherein at least some of the first fiber plies are placed onto the recessed region to substantially conform therewith;
placing a cored member onto the recessed, first fiber plies, the cored member complementarily configured to conform to the recessed portion;
arranging a second plurality of fiber plies onto the first plurality of fiber plies and onto the cored member to substantially form the composite structure;
pressurizing an outer surface of the composite assembly with a first pressure; and
pressurizing the inner surface of the pressurizable members with a second pressure, wherein the first pressure and the second pressure operate to compress the fiber plies without crushing the cored member.

2. The method of claim 1, further comprising increasing a chamfer angle of the cored member along one or more edges of the cored member.

3. The method of claim 1 wherein the first plurality of fiber plies forms an exterior surface of the composite structure.

4. The method of claim 1 wherein the first plurality of fiber plies forms an interior surface of the composite structure.
